(19) United States
(12) Patent Application Publication
(10) Pub. No.: US 2008/0101717 A1
(43) Pub. Date: May 1, 2008

(54) Image edge enhancing apparatus and method

(75) Inventor: Sheng-Feng Ho, Taipei (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/798,227

(22) Filed: May 11, 2007

(30) Foreign Application Priority Data
Nov. 1, 2006 (TW) 095140483

(51) Int. Cl. G06T 5/00

(52) U.S. Cl. 382/266

(57) ABSTRACT

An image edge enhancing method adjusts a luminance of a target pixel of a digital image. The target pixel has an original luminance. The method includes the steps of: performing an edge boosting operation on the target pixel to obtain an edge enhanced luminance; performing an edge detection on the target pixel to obtain an edge direction of the target pixel; determining an adjusting range according to a luminance of at least one neighboring pixel adjacent to the target pixel along the edge direction; and adjusting the edge enhanced luminance according to the adjusting range so that an adjusted edge enhanced luminance is not too bright or too dark, thereby suppressing a halo effect and enhancing a sharpness of the image edge.

This application claims the benefit of Taiwan application Serial No. 095140483, filed Nov. 1, 2006, the subject matter of which is incorporated herein by reference.

### BACKGROUND OF THE INVENTION

1. Field of the Invention

The invention relates in general to an image edge enhancing method, and more particularly to an image edge enhancing method of suppressing a halo effect.

2. Description of the Related Art

Image edge boosting technology is used to specially adjust the contrast or the luminance to make the profile of the image clearer and the frame becomes unambiguous to human eyes.

FIG. 1 shows a schematic illustration of a conventional example of an enhanced image edge, wherein the horizontal axis represents the position along a specific direction, and the vertical axis represents the luminance. The curve 110 shows the relationship between the position and the luminance of the original image edge along this specific direction. The curve 120 shows the relationship between the position and the luminance of the enhanced image edge along this specific direction. The enhanced image edge is obtained after performing an image edge boosting operation on the original image edge of the curve 110.

The original luminance of the pixel at position h1 is V(h1) corresponding to the darker portion of the original image edge. The original luminance of the pixel at position h2 is V(h2) corresponding to the brighter portion of the original image edge. The slope of the curve 110 between the positions h1 and h2 determines the sharpness of the original image edge.

The curve 120 is obtained by locally brightening the brighter portion of the original image edge and locally darkening the darker portion of the original image edge. The slope of the curve 120 between the positions h1 and h2 is steeper than that of the curve 110, which means that the sharpness is enhanced.

However, when the image edge enhancing method over increases the slope of the curve 110, a halo effect occurs. For example, the luminance of the pixel near position h2 on the curve 120 is over increased, because the luminance is higher than the maximum luminance (i.e. V(h2)) of the original image edge; and the luminance of the pixels near position h1 is over reduced, because the luminance is lower than the minimum luminance (i.e. V(h1)) of the original image edge. Thus, the halo effect occurs near positions h1 and h2 of the enhanced image edge which makes the enhanced image edge unnatural.

### SUMMARY OF THE INVENTION

The invention is directed to an image edge enhancing method. When the edge enhanced luminance of a target pixel is over-increased or over-reduced, the edge enhanced luminance can be reduced or increased according to an adjusting range determined by a neighboring pixel adjacent to the target pixel. Thus, the method can avoid halo effect (due to over-increased and over-reduced) while sharpening the edge of the original image.

According to a first aspect of the invention, an image edge enhancing method is provided. The method is used to adjust a luminance of a target pixel of a digital image. The target pixel has an original luminance. The method includes the steps of: performing an edge boosting operation on the target pixel to obtain an edge enhanced luminance of the target pixel; performing an edge detection on the target pixel to obtain an edge direction of the target pixel; determining an adjusting range along the edge direction according to a luminance of at least one neighboring pixel adjacent to the target pixel; and adjusting the edge enhanced luminance according to the adjusting range.

According to a second aspect of the invention, an image edge enhancing apparatus for adjusting a luminance of a target pixel of a digital image is provided. The target pixel has an original luminance. The image edge enhancing apparatus includes an edge boosting unit, an edge detecting unit and an operating unit. The edge boosting unit performs an edge boosting operation on the digital image to obtain an edge enhanced luminance of the target pixel. The edge detecting unit performs an edge detection on the digital image to obtain an edge direction of the target pixel. The operating unit determines an adjusting range along the edge direction according to a luminance of at least one neighboring pixel adjacent to the target pixel, and adjusts the edge enhanced luminance according to the adjusting range.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing a conventional example for enhancing an image edge.

FIG. 2 is a flow chart showing an image edge enhancing method according to an embodiment of the invention.

FIG. 3A is a schematic illustration showing an original image edge and an enhanced image edge of a digital image according to one example.

FIG. 3B is a schematic illustration redrawing the original image edge and the enhanced image edge in FIG. 3A.

FIG. 4 is a schematic illustration showing an adjusted enhanced image edge by applying the image edge enhancing method on the original image edge in FIG. 3A.

FIG. 5 is a schematic illustration redrawing the original image edge and the enhanced image edge in FIG. 3A and the adjusted enhanced image edge in FIG. 4.

FIGS. 6A and 6B are schematic illustrations showing an adjusted enhanced image edge obtained according to another method for adjusting the edge enhanced luminance.

FIG. 7 shows an image edge enhancing apparatus according to the embodiment of the invention.

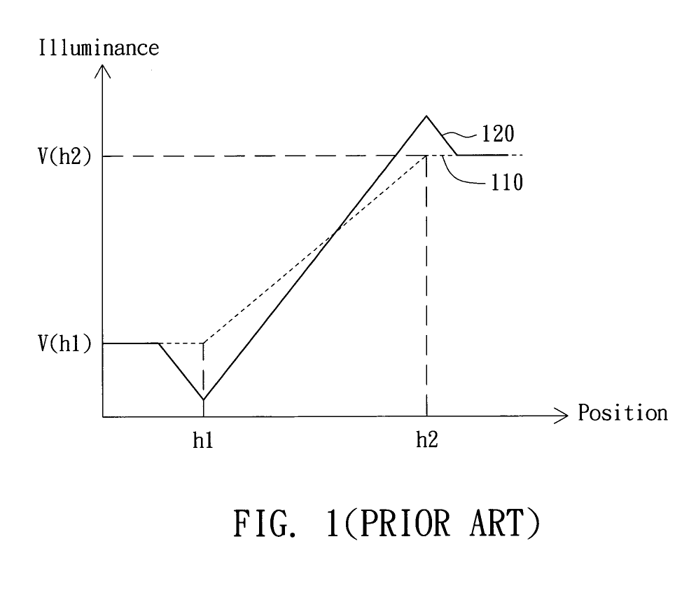

### DETAILED DESCRIPTION OF THE INVENTION

The image edge enhancing method according to the embodiment of the invention is used to adjust a luminance of a target pixel of a digital image. The image edge enhancing method of the invention performs an edge boosting operation or an edge enhancement operation on the target pixel to obtain an edge enhanced luminance of the target pixel. Then, the image edge enhancing method determines an adjusting range according to luminances of neighboring pixels adjacent to the target pixel, and then adjusts the edge enhanced luminance according to the adjusting range. If the edge enhanced luminance is over-increased or over-reduced, the method can reduce or increase the edge enhanced luminance according to the adjusting range. Thus, the method can avoid halo effect (due to over-increased or over-reduced) while sharpening the edge of the original image. Applying the image edge enhancing method according to the embodiment of the invention can adjust the luminance of each pixel in the digital image so that not only the image edge can be enhanced but also the halo effect can be suppressed.

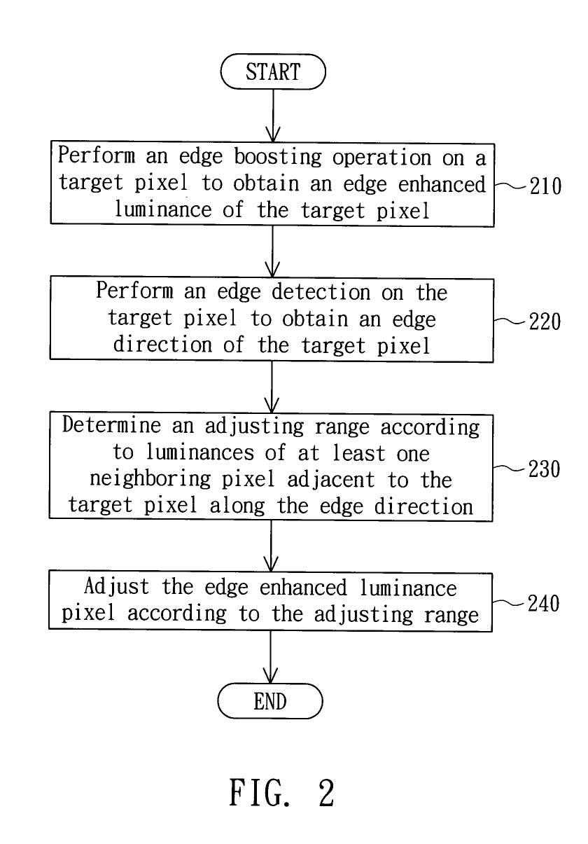

FIG. 2 is a flow chart showing an image edge enhancing method according to an embodiment of the invention. Referring to FIG. 2, the image edge enhancing method according to the embodiment of the invention adjusts a luminance of a target pixel of a digital image. This target pixel has an original luminance. In step 210, perform an edge boosting operation on the target pixel to obtain an edge enhanced luminance of the target pixel. This edge boosting operation, such as unsharp masking, locally brightens the brighter portion of the original image edge and locally darkens the darken portion to achieve the edge boosting effect.

In step 220, perform an edge detection on the target pixel to obtain an edge direction of the target pixel. In this embodiment of the invention, the edge detections, such as horizontal direction, vertical direction and diagonal directions, are performed on the target pixel. Sobel spatial mask, for example, is adopted to perform the edge detection corresponding to each direction. One edge direction having the strongest edge intensity among the different directions obtained by the edge detection step is selected as the edge direction of the target pixel. It has to be noted that the order of steps 210 and 220 can be switched.

In step 230, determine an adjusting range along the edge direction according to the luminance of at least one neighboring pixel adjacent to the target pixel. In this embodiment of the invention, the pixels within two continuous units or pixels (including two units or pixels) along the edge direction of the target pixel serve as the neighboring pixels. The adjusting range for the target pixel is determined according to the original maximum luminance and the original minimum luminance of these neighboring pixels.

In step 240, adjust the edge enhanced luminance of the target pixel according to the adjusting range. In this embodiment of the invention, when the edge enhanced luminance of the target pixel is lower than the lower bound of the adjusting range, the edge enhanced luminance is increased to be equal to the lower bound of the adjusting range. When the edge enhanced luminance of the target pixel is higher than the upper bound of the adjusting range, the edge enhanced luminance is reduced to be equal to the upper bound of the adjusting range. When the edge enhanced luminance of the target pixel falls within the adjusting range, the edge enhanced luminance is kept unchanged.

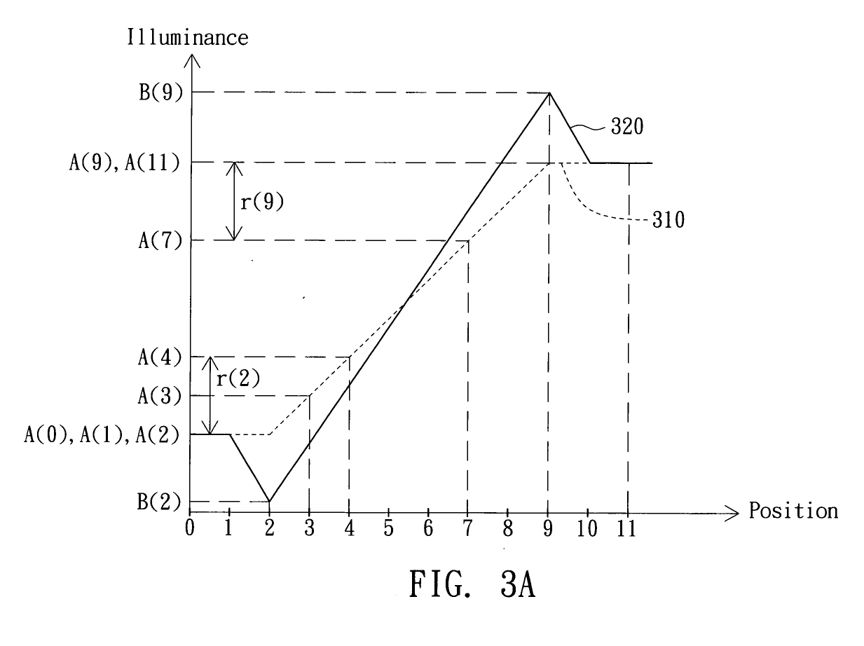

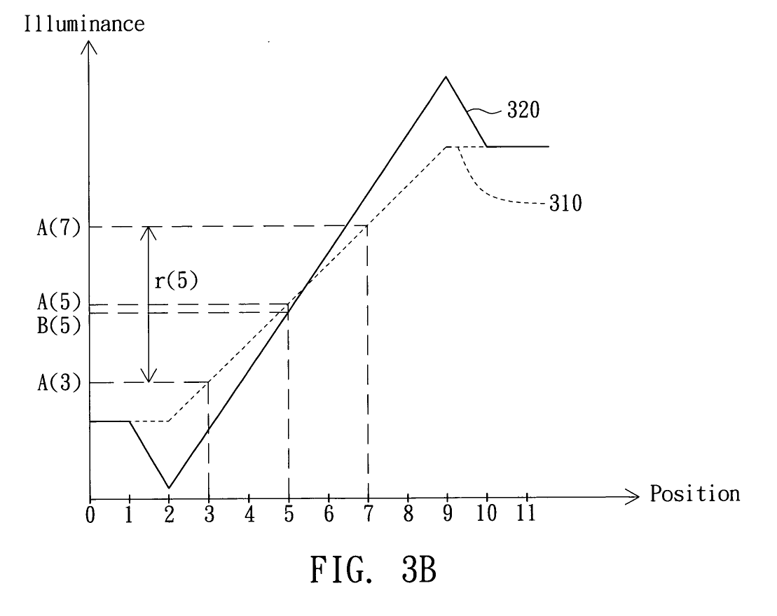

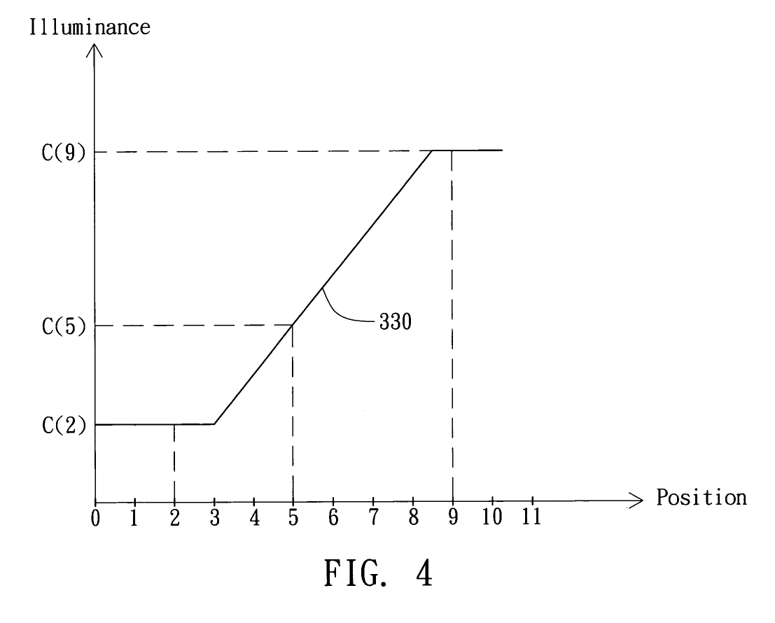

FIG. 3A is a schematic illustration showing an original image edge and an enhanced image edge of a digital image according to one example. As shown in FIG. 3A, the curve 310 represents the relationship between the position and the luminance of the original image edge along its edge direction, and the curve 320 represents the relationship between the position and the luminance of the enhanced image edge along the edge direction, wherein the enhanced image edge is generated after the edge boosting operation is performed (in step 210) on the pixels of the original image edge. FIG. 4 is a schematic illustration showing an adjusted enhanced image edge obtained in step 240. As shown in FIG. 4, the curve 330 represents the relationship between the position and the luminance of the adjusted enhanced image edge along the edge direction. The image edge enhancing method according to the embodiment of the invention will be described with reference to the following cases.

### First Case

Please refer to FIG. 3A and FIG. 4. The image edge enhancing method according to the embodiment of the invention will be described on the pixel at position 2 as example (i.e. the pixel at position 2 is the target pixel). As shown in FIG. 3A, the pixel at position 2 has an original luminance A(2). In step 210, the edge boosting operation is performed on the pixel at position 2 to obtain an edge enhanced luminance B(2) of the pixel at position. Because the pixel at position 2 is located at the darker portion of the original image edge, the edge enhanced luminance B(2) of the pixel at position 2 will be lower than the original luminance A(2) of the pixel. In step 220, the edge detection is performed on the pixel at position 2 to obtain the edge direction of the pixel at position 2. In the embodiment of the invention, the edge direction of the pixel at position 2 is the same as the edge direction of the original image edge.

In FIG. 3A, the pixels at positions 0˜4 are neighboring pixels to the pixel at position 2 along the edge direction (within two continuous units or pixels adjacent to the pixel position 2). In this embodiment, the original luminances of the pixels at positions 0˜4 are respectively A(0) A(1), A(2), A(3) and A(4) having the relationship of A(0)=A(1)=A(2)<A(3)<A(4), wherein A(0) (and A(1)) and A(4) are respectively the original minimum luminance and the original maximum luminance among the luminances of the pixels at positions 0˜4. Thus, in step 230, the adjusting range r(2) ranges is determined as between A(0) and A(4) wherein the lower bound A(0) of the adjusting range r(2) is equal to the original luminance A(2) of the pixel at position 2.

Because the edge enhanced luminance B(2) of the pixel at position 2 is lower than the lower bound A(0) of the adjusting range r(2), the edge enhanced luminance B(2) is increased to be equal to the lower bound A(0) in step 240, to obtain an adjusted edge enhanced luminance C(2) corresponding to the pixel at position 2 in FIG. 4.

### Second Case

Illustrations will be made by taking the pixel at position 9 in the original image edge in FIG. 3A as an example. The pixel at position 9 has an original luminance A(9). In step 210, the edge boosting operation is performed on the pixel at position 9 to obtain an edge enhanced luminance B(9) of the pixel at position 9 in FIG. 3A. Because the pixel at position 9 is located at the brighter portion of the original image edge, the edge enhanced luminance B(9) of the pixel at position 9 is greater than the original luminance A(9) of the pixel.

In step 220, the edge detection is performed on the pixel at position 9 to obtain the edge direction of the pixel at position 9. Similarly, in the embodiment of the invention, the edge direction of the pixel at position 9 is also the same as the edge direction of the original image edge.

In FIG. 3A, the pixels at positions 7˜11 are neighboring pixels adjacent to the pixel at position 9 along the edge direction (within two continuous units or pixels adjacent to the pixel position 9). The original luminances A(7) and A(11) of the pixels at positions 7 and 11 are respectively the original minimum luminance and the original maximum luminance among the neighboring pixels (at positions 7˜11). Thus, the adjusting range r(9) obtained in step 230 ranges between A(7) and A(11) wherein the upper bound A(11) of the adjusting range r(9) is equal to the original luminance A(9) of the pixel at position 9.

Because the edge enhanced luminance B(9) of the pixel at position 9 is higher than the upper bound A(11) of the adjusting range, the edge enhanced luminance B(9) is reduced to be equal to the upper bound A(11) in step 240 so that the adjusted edge enhanced luminance C(9) corresponding to the pixel at position 9 in FIG. 4 is obtained.

### Third Case

Both the curve 310 and the curve 320 of FIG. 3A are redrawn in FIG. 3B. In this case, taking the pixel at position 5 as example. As shown in FIG. 3B, the pixel at position 5 has an original luminance A(5). In step 210, the edge boosting operation is performed on the pixel at position.5, and then an edge enhanced luminance B(5) of the pixel at position 5 is obtained. The edge enhanced luminance B(5) is slightly lower than the original luminance A(5) of this pixel.

In step 220, the edge detection is performed on the pixel at position 5 to obtain the edge direction of the pixel at position 5. Similarly, the edge direction of the pixel at position 5 in the embodiment of the invention is also the same as the edge direction of the original image edge.

Similarly, the pixels at positions 3˜7 in FIG. 3B are the neighboring pixels adjacent to the pixel at position 5 along the edge direction (within two continuous units or pixels adjacent to the pixel position 5). The original luminances A(3) and A(7) of the pixels at positions 3 and 7 are respectively the minimum luminance and the maximum luminance among the neighboring pixels (at positions 3˜7). Thus, the adjusting range r(5) obtained in step 230 ranges between A(3) and A(7).

In FIG. 3B, the edge enhanced luminance B(5) of the pixel at position 5 falls within the adjusting range r(5). So, the edge enhanced luminance B(5) does not have to be changed in step 240. Thus, in FIG. 4, the edge enhanced luminance C(5), which corresponds to the pixel at position 5 obtained in step 240, is the same as B(5).

The adjusted enhanced image edge (i.e. the curve 330 in FIG. 4) is obtained after performing the edge boosting operations and the image edge enhancing method of the embodiment of the invention on all the pixels of the curve 310 of the original image edge.

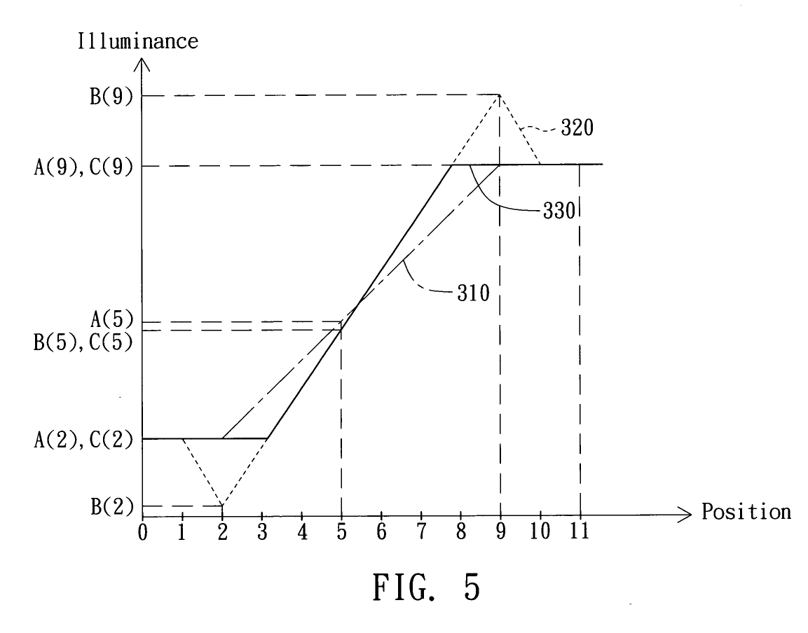

The curves 310, 320 and 330 are redrawn in FIG. 5 to illustrate the effect of the image edge enhancing method according to the embodiment of the invention. The slope between the positions 2 and 9 of the curve 320 is greater than that of the curve 310. That is, the sharpness of the enhanced image edge is greater than the original image edge.

However, the edge enhanced luminance on a darker portion of the enhanced image edge in the curve 320 (i.e., the pixels near position 2) may be lower than the lower bound of the adjusting range. The edge enhanced luminance on a brighter portion of the enhanced image edge (i.e., the pixels near position 9) may be higher than the upper bound of the adjusting range. That means, the edge enhanced luminance on the pixel near position 2 is over-reduced and the edge enhanced luminance on the pixel near position 9 is over-increased after the edge boosting operation so that the halo effect may occur.

Thus, step 240 adjusts the edge enhanced luminances of all the pixels on the enhanced image edge in the curve 320 according to the adjusting range which is determined by the original luminances of the neighboring pixels along the edge direction of the image edge. In the curve 330, when the edge enhanced luminance of the pixel near position 2 is over-reduced (i.e. lower than the lower bound of the adjusting range), the edge enhanced luminance is adjusted to be equal to the lower bound of the adjusting range. When the edge enhanced luminance of the pixel near position 9 is over-increased (i.e. higher than the upper bound of the adjusting range), the edge enhanced luminance is adjusted to be equal to the upper bound of the adjusting range.

Thus, compared with the curve 310, the middle region between the brightest portion and the darkest portion of the adjusted enhanced image edge in the curve 330 becomes narrower, which means that the sharpness of the adjusted enhanced image edge is increased. In addition, the pixels near position 2 and position 9 are not too dark or too bright. Thus, the image edge enhancing method according to the embodiment of the invention would not only enhances the sharpness of the image edge and the contrast of the image edge but also suppresses the halo effect.

When the edge enhanced luminance of the target pixel falls within the adjusting range thereof, another adjusting method may be adopted. When the edge enhanced luminance of the target pixel is lower than the original luminance thereof, the edge enhanced luminance is reduced. When the edge enhanced luminance of the target pixel is higher than the original luminance thereof, the edge enhanced luminance thereof is increased. Consequently, it is also not only enhances the sharpness of the image edge but also suppress the halo effect.

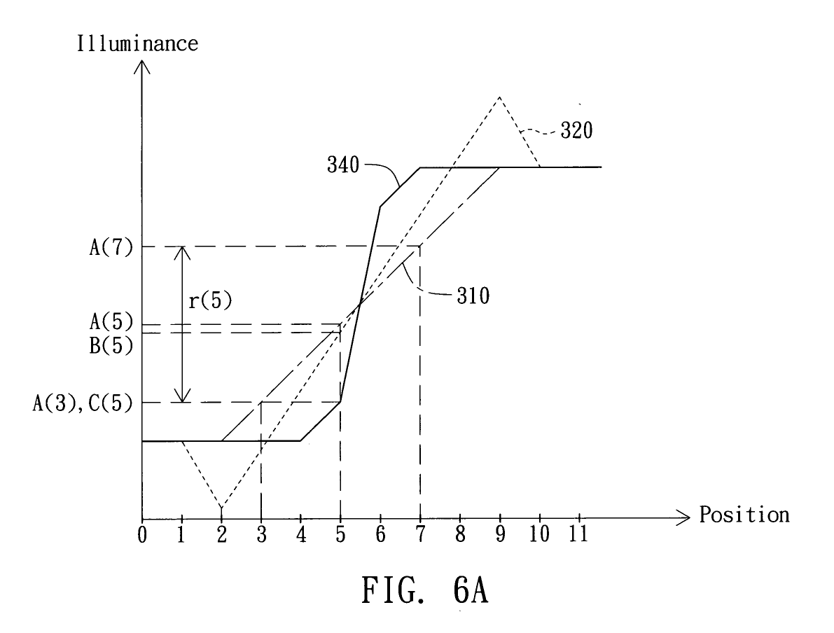

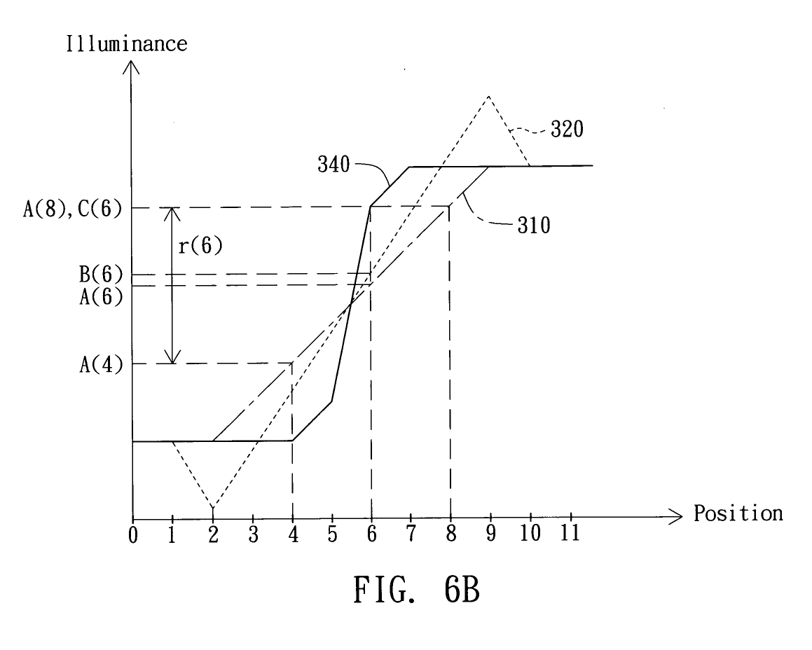

FIG. 6A is a schematic illustration showing an adjusted enhanced image edge obtained by another adjusting way that adjusting the edge enhanced luminance of the pixels on the curve 320. FIG. 6A includes the curve 340 (adjusted enhanced curve) and the redrawn curve 310 (original curve) and curve 320 (enhanced curve). The curve 340 represents the relationship between the position and the luminance of the adjusted enhanced image edge along the edge direction.

Illustrations will be made taking the pixel at position 5 as example in the third case. After step 210, as shown in FIG. 6A, the edge enhanced luminance B(5) of the pixel at position 5 falls within the adjusting range r(5) (i.e., between A(3) and A(7)), and the edge enhanced luminance B(5) is lower than the original luminance A(5) of this pixel. In this manner, the edge enhanced luminance B(5) is reduced so that the adjusted edge enhanced luminance C(5) is equal to the lower bound A(3) of the adjusting range.

The adjusting method will be described taking the pixel at position 6 as example. For the sake of explanation, the curves 310, 320 and 340 in FIG. 6A are redrawn in FIG. 6B. After step 210, the edge enhanced luminance B(6) of the pixel at position 6 falls within the adjusting range r(6) (i.e., between A(4) and A(8)), and the edge enhanced luminance B(6) is higher than the original luminance A(6) of this pixel. The pixels at positions 4˜8 are the neighboring pixels adjacent to the pixel at position 6, and the original luminances A(4) and A(8) of the pixels at positions 4 and 8 are respectively the minimum luminance and the maximum luminance among neighboring pixels at positions 4˜8. In this manner, the edge enhanced luminance B(6) is increased so that the adjusted edge enhanced luminance C(6) is equal to the upper bound A(8) of the adjusting range r(6).

According to this adjusting method, the pixels on the enhanced image edge of the curve 320 are adjusted. The adjusted enhanced image edge of the curve 340 is then obtained. Compared with the curve 310, the middle region between the brightest portion and the darkest portion of the adjusted enhanced image edge in the curve 340 becomes narrower, which means that the sharpness of the adjusted enhanced image edge is enhanced. In addition, the pixels near the brightest portion and the darkest portion of the adjusted enhanced image edge do not become too bright or too dark. Thus, the sharpness of the image edge and the contrast of the image edge can be enhanced, and the halo effect can be suppressed.

In the image edge enhancing method according to this embodiment of the invention, the pixels within two continuous units or pixels (including two units or pixels) along the edge direction of the target pixel serve as the neighboring pixels adjacent to the target pixel used to determine an adjusting range. In practice, it is possible to take other proper distance, for example, fall within one, three or four units or pixels from the target pixel, to serve as the neighboring pixels adjacent to the target pixel (not limited to two continuous units or pixels). In step 230, the maximum luminance and the minimum luminance among the neighboring pixels serve as the upper bound and the lower bound of the adjusting range. In practice, however, it is possible to determine the adjusting range using other methods according to the luminances of the neighboring pixels.

In step 240 of the image edge enhancing method according to the embodiment of the invention, when the edge enhanced luminance of the target pixel is lower than the lower bound of the adjusting range, the edge enhanced luminance is increased to be equal to the lower bound of the adjusting range. When the edge enhanced luminance of the target pixel is higher than the upper bound of the adjusting range, the edge enhanced luminance is reduced to be equal to the upper bound of the adjusting range. When the edge enhanced luminance of the target pixel falls within the adjusting range, the edge enhanced luminance is kept unchanged, or the edge enhanced luminance is adjusted to be equal to the upper bound or the lower bound of the adjusting range. In practice, it is possible to adjust the edge enhanced luminance by other methods according to the adjusting range so that the adjusted edge enhanced luminance will not become too bright or too dark while enhancing the sharpness of the image edge.

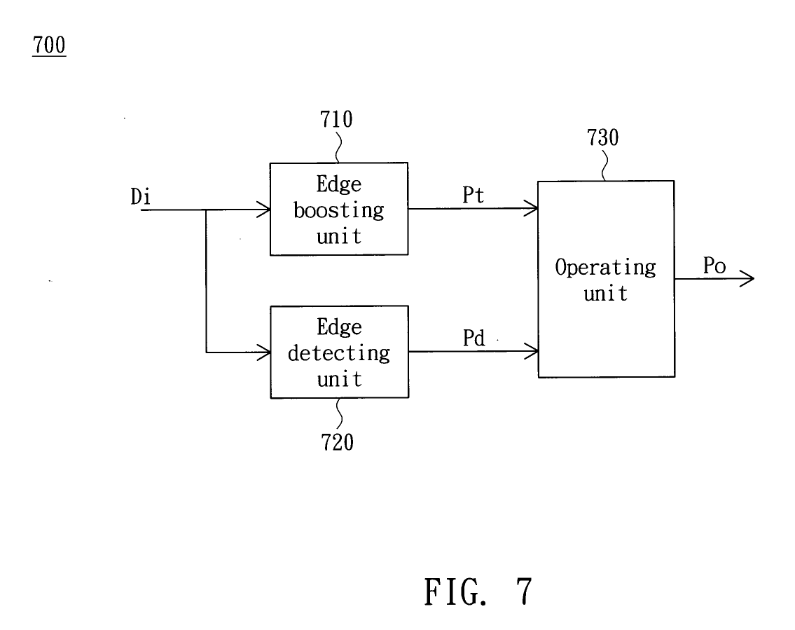

FIG. 7 shows an image edge enhancing apparatus 700 according to the embodiment of the invention. Referring to FIG. 7, the image edge enhancing apparatus 700 includes an edge boosting unit 710, an edge detecting unit 720 and an operating unit 730. The image edge enhancing apparatus 700 adjusts the luminance of a target pixel of a digital image Di. The target pixel has an original luminance.

The edge boosting unit 710 and the edge detecting unit 720 receive the digital image Di. The edge boosting unit 710 performs edge boosting operation on the digital image and obtains an edge enhanced luminance Pt of the target pixel. The edge detecting unit 720 performs edge detection according to the digital image and obtains an edge direction Pd of the target pixel.

The operating unit 730 performs the image edge enhancing method. The operating unit 730 determines an adjusting range according to the luminance of at least one neighboring pixel adjacent to the target pixel along the edge direction Pd in the digital image Di, and adjusts the edge enhanced luminance Pt according to the adjusting range to obtain an adjusted edge enhanced luminance Po.

In this image edge enhancing method according to the embodiment of the invention, the edge enhanced luminance of the target pixel would be reduced or increased according to the adjusting range determined by the neighboring pixels adjacent to the target pixel if the edge enhanced luminance obtained by the edge boosting operation performed on the target pixel is over-reduced or over-increased. Thus, the halo effect can be avoided while enhancing the image edge. Therefore, using the image edge enhancing method according to the embodiment of the invention to adjust the luminance of each pixel in the digital image can produce the enhanced image edge and suppress the halo effect at the same time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image edge enhancing method for adjusting a luminance of a target pixel of a digital image, the target pixel having an original luminance, the method comprising the steps of:
performing an edge boosting operation on the target pixel to obtain an edge enhanced luminance of the target pixel;
performing an edge detection on the target pixel to obtain an edge direction of the target pixel;
determining an adjusting range according to luminances of at least one neighboring pixel adjacent to the target pixel along the edge direction; and
adjusting the edge enhanced luminance according to the adjusting range.

2. The method according to claim 1, wherein in the step of adjusting the edge enhanced luminance, reducing the edge enhanced luminance when the edge enhanced luminance is higher than an upper bound of the adjusting range.

3. The method according to claim 1, wherein in the step of adjusting the edge enhanced luminance, increasing the edge enhanced luminance when the edge enhanced luminance is lower than a lower bound of the adjusting range.

4. The method according to claim 1, wherein in the step of adjusting the edge enhanced luminance, keeping the edge enhanced luminance unchanged when the edge enhanced luminance is within the adjusting range.

5. The method according to claim 1, wherein in the step of adjusting the edge enhanced luminance, increasing the edge enhanced luminance when the edge enhanced luminance is higher than the original luminance and the edge enhanced luminance is within the adjusting range.

6. The method according to claim 1, wherein in the step of adjusting the edge enhanced luminance, reducing the edge enhanced luminance when the edge enhanced luminance is lower than the original luminance and the edge enhanced luminance is within the adjusting range.

7. The method according to claim 1, wherein in the step of determining the adjusting range, the adjusting range is determined according to the luminances of pixels within two continuous units or pixels adjacent to the target pixel along the edge direction.

8. The method according to claim 1, wherein the adjusting range is between a maximum luminance and a minimum luminance among the luminances of the at least one neighboring pixel adjacent to the target pixel along the edge direction.

9. An image edge enhancing apparatus for adjusting a luminance of a 5 target pixel of a digital image, the target pixel having an original luminance, the apparatus comprising:
an edge boosting unit for performing an edge boosting operation on the digital image to obtain an edge enhanced luminance of the target pixel;
an edge detecting unit for performing an edge detection on the digital image to obtain an edge direction of the target pixel; and
an operating unit for determining an adjusting range according to luminances of at least one neighboring pixel adjacent to the target pixel along the edge direction in the digital image, and adjusting the edge enhanced luminance according to the adjusting range.

10. The apparatus according to claim 9, wherein when the edge enhanced luminance is higher than an upper bound of the adjusting range, the operating unit reduces the edge enhanced luminance.

11. The apparatus according to claim 9, wherein when the edge enhanced luminance is lower than a lower bound of the adjusting range, the operating unit increases the edge enhanced luminance.

12. The apparatus according to claim 9, wherein when the edge enhanced luminance is within the adjusting range, the edge enhanced luminance is kept unchanged.

13. The apparatus according to claim 9, wherein when the edge enhanced luminance is higher than the original luminance and the edge enhanced luminance is within the adjusting range, the operating unit increases the edge enhanced luminance.

14. The apparatus according to claim 9, wherein when the edge enhanced luminance is lower than the original luminance and the edge enhanced luminance is within the adjusting range, the operating unit reduces the edge enhanced luminance.

15. The apparatus according to claim 9, wherein the operating unit determines the adjusting range according to the luminances of pixels within two continuous units or pixels adjacent to the target pixel along the edge direction, and adjusts the edge enhanced luminance according to the adjusting range.

16. The apparatus according to claim 9, wherein the adjusting range is between a maximum luminance and a minimum luminance among the luminances of at least one neighboring pixel adjacent to the target pixel along the edge direction.
